(19) United States
(12) Patent Application Publication
(10) Pub. No.: US 2016/0096043 A1
(43) Pub. Date: Apr. 7, 2016

(54) ROPING HARNESS

(71) Applicant: ZEDEL, Crolles (FR)

(72) Inventor: Loïc BLONDEAU, La Tronche (FR)

(21) Appl. No.: 14/876,430

(22) Filed: Oct. 6, 2015

(30) Foreign Application Priority Data
Oct. 7, 2014 (FR) 1459578

(51) Int. Cl. A62B 35/00

(52) U.S. Cl. CPC A62B 35/0006

(57) ABSTRACT

A belt of roping harness including flexible support strip designed to support dorsal part of user's body, adjustment device of the circumference of belt having first and second ends fixed to support strip in first and second positions, and at least three resistance threads each stitched onto adjustment device in specific third and fourth positions. At least one of the resistance threads presents longer length than the distance separating the third and fourth positions along the support strip. The belt also includes securing means of the resistance threads configured so as to secure the resistance threads with the support strip in manner separated from one another in orthogonal direction to longitudinal axis of the support strip. Also relates to a pair of leg loops including similar features. Finally it relates to roping harness including belt and/or pair of leg loops provided with the above-mentioned features.

### BACKGROUND OF THE INVENTION

The invention relates to a roping harness belt and to a roping harness comprising one such belt and a pair of leg loops.

### STATE OF THE ART

In the field of rock climbing, mountaineering, ski-mountaineering, or for performing work at heights, roping harnesses enable safety of persons to be ensured.

In conventional manner, a roping harness comprises a belt and a pair of leg loops. Depending on the type of use, the belt and leg loop can be more or less thick in order to ensure user comfort. For example, a harness designed for working at heights has to be particularly comfortable to allow prolonged use. In mountain climbing, the harness also has to be comfortable so as not to injure the climber if he falls in a route when he is leader.

In the field of mountaineering and ski-mountaineering, the harness is mainly intended for roping of a roped party. The thickness of the belt and of the leg loop can be thinner as they are seldom placed under tension. This results in a gain of weight and compactness appreciated by sports persons, but to the detriment of their comfort.

In order to guarantee good conditions of use whatever the category of sport involved, it is important to make a trade-off between user comfort, the weight of the roping harness and its compactness. In this way, the harness is multipurpose and the user does not need to have several items of equipment at his disposal.

### OBJECT OF THE INVENTION

One object of the invention consists in providing a belt for a roping harness comprising:
a flexible support strip designed to support the dorsal part of the user's body,
an adjustment device of the circumference of the belt having first and second ends fixed to the support strip in first and second positions,
at least three resistance threads each sewn onto the adjustment device in specific third and fourth positions,
at least one of the resistance threads presenting a greater length than the distance separating its third and fourth positions along the support strip,
securing means of the resistance threads configured so as to secure the resistance threads with the support strip in a manner separated from one another in an orthogonal direction to a longitudinal axis of the support strip.

According to one feature of the invention, the resistance threads can be secured to the support strip so as to allow longitudinal sliding of the resistance threads with respect to the support strip. Securing of the resistance threads on the support strip can be performed by means of at least one securing thread stitched in the support strip on each side of the associated resistance thread to limit the lateral movement with respect to the support strip. Each resistance thread can for example be secured by the securing thread stitched in zig-zag manner in the support strip, two consecutive stitches being able to be made on each side of the resistance thread. A securing thread can be associated with several resistance threads so as to secure several resistance threads with the support strip.

The resistance threads can also be secured on the support strip by means of a securing thread stitched in the support strip in a secant direction to the longitudinal axis of the support strip.

The resistance threads can also be fixed punctually onto the support strip. The resistance threads can then be secured on the support strip by means of a securing thread stitched in the support strip in an orthogonal direction to the longitudinal axis of the support strip.

The resistance threads can further be made from polyethylene having at least 100,000 monomers per molecule, and having a molar mass approximately equal to 3.10⁶ g/mol.

Furthermore, the belt of the roping harness can comprise at least one strengthening screen designed to protect the user's pelvis.

Furthermore, the support strip can be a mesh screen and be made from polypropylene. According to one embodiment the support strip can be of reduced thickness at the ends thereof. The support strip can have a thickness less than or equal to 1.5 mm, preferably less than or equal to 1 mm.

The roping harness belt can further comprise at least five resistance threads.

The invention also relates to a pair of leg loops of a roping harness comprising:
two flexible support strips,
at least three resistance threads fixed to the longitudinal ends of the two support strips and designed to connect the two support strips, the resistance threads having at least two different lengths so as to be maintained in separated manner from one another in an orthogonal direction to the longitudinal axes of the support strips.

Finally, the invention relates to a harness comprising a belt and/or a pair of leg loops provided with the above-mentioned features.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 represents a schematic view of a roping harness,

FIG. 2a illustrates a belt of a roping harness according to one embodiment of the invention in schematic manner,

FIG. 2b presents a detail of manufacturing of the roping harness according to the embodiment illustrated in FIG. 2a,

FIG. 3 schematically illustrates an embodiment of the pair of leg loops.

### DETAILED DESCRIPTION

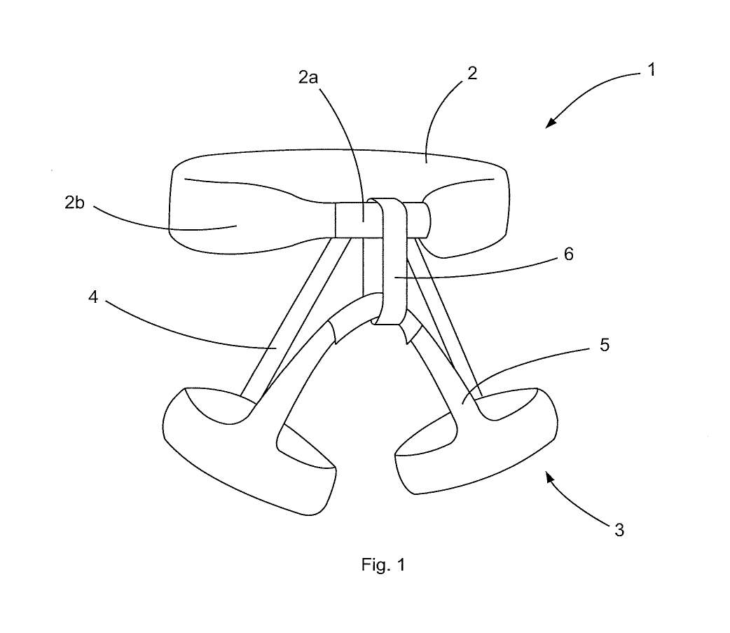

A roping harness 1 such as the one schematically represented in FIG. 1 comprises a belt 2 provided with a waist band 2b associated with an adjustment device 2a. The harness 1 also has a pair of leg loops 3, each leg loop 3 being connected to the dorsal part of the belt 2 advantageously by two flexible straps 4, and to the ventral part by a bridging hasp 5 via a central ring 6.

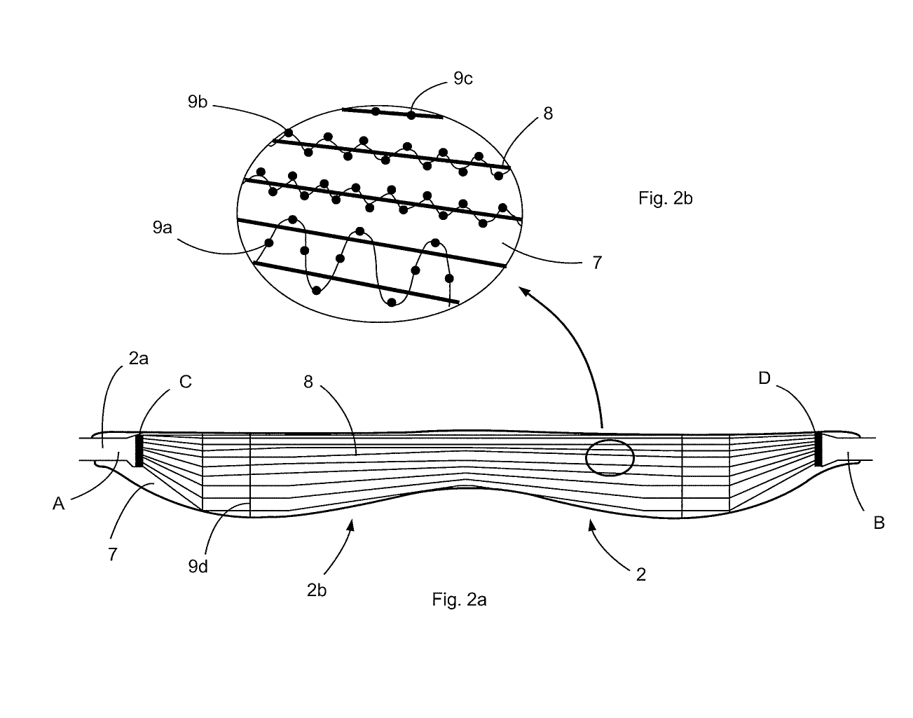

As represented in FIG. 2a, the adjustment device 2a is fixed in first and second positions A and B onto a support strip 7 of the waist band 2b. The adjustment device 2a is configured so as to adjust the circumference of the waist band so as to enable the size of the belt 2 to be adjusted to the corpulence of the user. For example purposes, the adjustment device 2a can comprise a strap which performs mechanical securing of the user in case of a fall.

One of the purposes of the support strip 7 is to provide user comfort by supporting at least the dorsal part of the users body. The support strip 7 does not have any mechanical resistance to tensile strength. It is incapable of supporting the user's weight.

The support strip 7 can be made from a flexible material 7 such as polypropylene. According to one embodiment, the support strip 7 can be perforated in order to improve its flexibility and its compactness and breathability, and to reduce the weight of the harness 1. It can for example be made in the form of a mesh screen.

In advantageous manner, the support strip 7 has a thickness less than or equal to 1.5 mm and even more preferentially less than or equal to 1 mm. It can be thinned at the longitudinal ends and thickened at the level of the iliac peaks (cf. FIG. 2a) so as to be more comfortable.

The strength of the belt is not only provided by the adjustment device 2a but also by resistance threads 8 fixed onto the adjustment device 2a in third and fourth positions C and D. According to a particular embodiment, the first and third positions A and C on the one hand and the second and fourth positions B and D on the other hand are one and the same.

In order to improve the compactness and flexibility of the harness, it is in fact judicious to use resistance threads 8 rather than straps. The resistance threads 8 are advantageously sewn in juxtaposed manner onto the adjustment device 2a. In this way, the seam is of small thickness in comparison with a seam where the threads are superposed on one another. The surface occupied by the seam on the adjustment device 2a is also smaller when resistance threads 8 are used instead of straps.

The resistance threads 8 ensure the strength in the dorsal part of the waist band 2b. The resistance threads 8 can for example be made from polyethylene having at least 100000 monomers per molecule, and having a molar mass approximately equal to 3.10⁶ g/mol. This type of material is known to have a very high tenacity and abrasion resistance and to enable user safety to be ensured in case of a fall, i.e. when the resistance threads 8 are suddenly subjected to a tensile stress.

In case of an impact, the support strip 7 placed between the resistance threads 8 and the user prevents the latter from being injured. The user could indeed be cut or burnt by the sudden tensioning of the resistance threads 8.

Due to the support strip, the pressure of the threads is distributed over the whole surface of the support strip 7, which greatly limits the sensation of discomfort.

As a variant, the resistance threads 8 can be placed between the user and the support strip 7, but this embodiment is less comfortable.

According to the invention, the belt 2 advantageously comprises at least three resistance threads 8. However, when the number of resistance threads is greater, the forces exerted on the user in case of dynamic use are weaker. It may therefore be judicious to provide a belt 2 which comprises four or five resistance threads 8, or even seven or more. Manufacturing a roping harness 1 with at least five threads rather than three increases the volume of the harness 1 very little, and enables the forces exerted on the resistance threads 8 in case of a fall to be better distributed. The resistance to forces of greater intensity is also improved. This can for example be useful for belaying corpulent persons.

On account of the fact that the harness is thinner compared with harnesses of the prior art in order to reduce the weight and volume of the latter, the resistance threads are not very well protected. Consequently, the use of several threads also enables the reliability of the harness to be guaranteed in case of a manufacturing defect of one of the threads, or in case of weakening of one of the threads when a shock occurs.

At least one of the resistance threads 8 is longer than the shortest distance separating the third and fourth positions, i.e. the points where the resistance threads 8 are stitched onto the adjustment device 2a. The axis passing through the third and fourth positions is considered in the following as being the longitudinal axis of the belt 2.

Preferentially, several resistance threads 8 are longer than the distance between the third and fourth positions. In this way, the resistance threads 8 can be secured in separated manner from one another on the support strip 7 in an orthogonal direction to the longitudinal axis. The force is distributed over a larger surface of the support strip 7, which limits discomfort in case of a fall or more generally when the belt is subjected to a tensile stress.

When tensioning occurs, the support strip 7 deforms slightly to snugly follow the shape of the user's pelvis, which places the resistance threads 8 in tension.

According to an advantageous embodiment, the resistance threads 8 are secured on the support strip 7 in spaced-apart manner in the orthogonal direction even when they are under tension. While keeping a constant spacing in the orthogonal direction, the resistance threads 8 can slide longitudinally if they are subjected to a tensile force.

One way to achieve this is to use securing threads 9, such as those represented in FIG. 2b. The latter are stitched into the support strip 7 in such a way that each stitch is made in proximity to one of the resistance threads 8 in order to limit their movement in the orthogonal direction. A single securing thread 9 can be used to secure several resistance threads 8 simultaneously to the support strip 7.

According to a first embodiment represented in FIG. 2b, a securing thread 9a can be stitched in zig-zag manner so as to secure several resistance threads 8 at the same time. It is also possible to secure the resistance threads 8 independently from one another by stitching a securing thread 9b in zig-zag manner on both sides of each resistance thread 8.

According to an alternative embodiment, the resistance threads 8 can also be stitched in punctual manner on the support strip 7 by means of the securing threads 9c. The stitches are then made directly on the resistance threads 8 for the latter to be fixed with respect to the support strip 7.

The resistance threads 8 can also be secured in a manner separated from one another on the support strip 7 by means of securing threads 9d stitched in a secant direction to the longitudinal axis, and preferentially in the orthogonal direction. These stitches can be made either alone or in addition to the stitches made in zig-zag manner.

According to a particular embodiment of the invention, at least one strengthening screen can be arranged between the support strip 7 and the resistance threads 8. The purpose of this strengthening screen is to improve the rigidity of the support strip 7 while at the same time keeping the harness very light. As the iliac peaks correspond to the zones that are the most exposed in case of tensioning of the harness 1, it may be advantageous to position a strengthening screen at the level of each iliac peak to prevent deformation of the harness 1 thereby avoiding any discomfort for the user.

As the strengthening screen is more rigid, it is advantageously located on the iliac peaks for ease of folding of the harness.

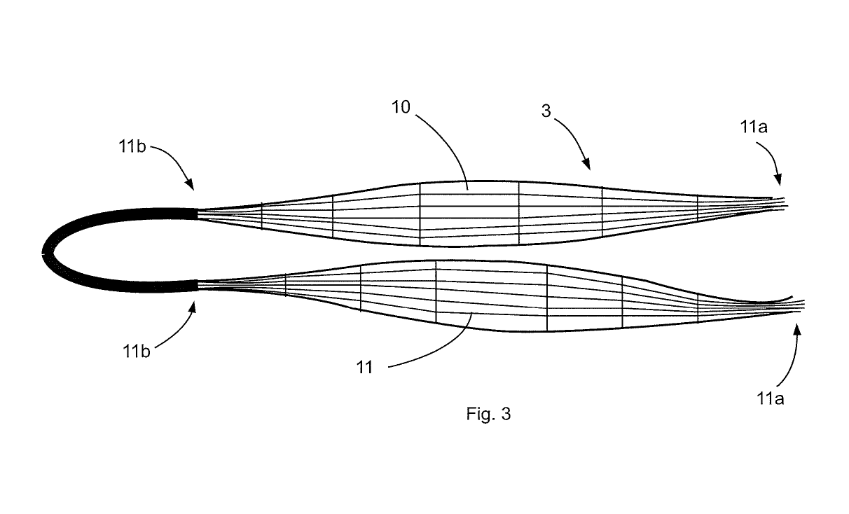

The pair of leg loops 3 can also be achieved by means of two independent flexible support strips 10 connected to one another by at least three resistance threads 11 (cf. FIG. 3), the resistance threads 11 forming the bridging hasp 5. According to an alternative embodiment, the pair of leg loops 3 can contain four or five resistance threads 11, or even more, for example to increase the strength of the harness 1 if the user is of large corpulence.

Each leg loop 3a and 3b is formed on the one hand by a seam of the ends 11a of the resistance threads 11 on a part 11b of the threads 11 situated at the edge of the bridging hasp 5, at the level of the junction between the bridging hasp 5 and the support strips 10, and on the other hand by the seam of the ends of each support strip 10 stitched onto one another. As for the belt 2, the strength of the leg loops 3a and 3b is ensured by the resistance threads 11.

Furthermore, in similar manner to the features developed in relation with the belt 2, the resistance threads 11 advantageously have different lengths so as to be kept at a distance from one another with respect to an orthogonal direction to the longitudinal axis of the support strips 10, the resistance thread 11 having a minimal length corresponding to that positioned on the longitudinal axis of the support strips 10. The resistance threads 11 can be secured to the support strips 10 in the same way as on the belt 2 while being able to slide in the direction of the longitudinal axis of the leg loops. Securing threads can be used to limit the movement of the resistance threads 11 in an orthogonal direction to the longitudinal axis of the leg loops. Seams secant to the longitudinal axis of the leg loops or seams stitched in zig-zag manner can for example be made.

User discomfort is then advantageously limited when the resistance threads 11 are subjected to a tensile stress, for example when the user sits in the harness 1.

The mechanical properties of the support strips 10 and of the resistance threads 11 are preferably identical to those of the support strip 7 and of resistance threads 8. The materials chosen to manufacture the belt 2 and the pair of leg loops 3 are preferably also identical.

As an alternative to the embodiment of the leg loops which has been described in the foregoing, it is quite conceivable to provide adjustable leg loops each comprising an adjustment device similar to the one described in relation with the belt 2 of the harness 1.

A roping harness 1 is thus obtained that is light, compact, solid and comfortable, and that is able to be used both in the scope of use in mountaineering or ski-mountaineering where lightness and compactness are of paramount importance, and in the scope of use in rock climbing where user comfort is the most important criterion.

1-17. (canceled)

18. A belt of a roping harness comprising:
a flexible support strip designed to support the dorsal part of the user's body,
an adjustment device of the circumference of the belt having first and second ends fixed to the support strip in first and second positions,
at least three resistance threads each sewn onto the adjustment device in specific third and fourth positions,
at least one of the resistance threads presenting a greater length than the distance separating its third and fourth positions along the support strip,
securing means of the resistance threads configured so as to secure the resistance threads with the support strip in a manner separated from one another in an orthogonal direction to a longitudinal axis of the support strip.

19. The belt of a roping harness according to claim 18, wherein the securing means of the resistance threads on the support strip are configured so as to allow longitudinal sliding of the resistance threads with respect to the support strip.

20. The belt of a roping harness according to claim 18, wherein at least one of the resistance threads is secured onto the support strip by means of at least one securing thread stitched into the support strip on each side of the associated resistance thread to limit the lateral movement of the resistance thread with respect to the support strip.

21. The belt of a roping harness according to claim 20, wherein at least one of the resistance threads is secured by a securing thread stitched in zig-zag manner in the support strip, two consecutive stitches being made on each side of the resistance thread.

22. The belt of a roping harness according to claim 20, wherein a securing thread is associated with several resistance threads so as to secure several resistance threads with the support strip.

23. The belt of a roping harness according to claim 18, wherein the resistance threads are kept secured on the support strip by means of a thread stitched in the support strip in a secant direction to the longitudinal axis of the support strip.

24. The belt of a roping harness according to claim 18, wherein the resistance threads are fixed punctually onto the support strip.

25. The belt of a roping harness according to claim 24, wherein the resistance threads are secured on the support strip by means of a thread stitched in the support strip in an orthogonal direction to the longitudinal axis of the support strip.

26. The belt of a roping harness according to claim 18, wherein the resistance threads are made from polyethylene having at least 100000 monomers per molecule and having a molar mass approximately equal to 3.106 g/mol.

27. The belt of a roping harness according to claim 18, comprising at least one strengthening screen designed to protect the user's pelvis.

28. The belt of a roping harness according to claim 18, wherein the support strip is a mesh screen.

29. The belt of a roping harness according to claim 18, wherein the support strip is made from polypropylene.

30. The belt of a roping harness according to claim 18, wherein the support strip is of reduced thickness at the ends.

31. The belt of a roping harness according to claim 18, wherein the support strip has a thickness less than or equal to 1.5 mm.

32. The belt of a roping harness according to claim 18, comprising at least five resistance threads.

33. A pair of leg loops of a roping harness comprising:
two flexible support strips,
at least three resistance threads fixed to the longitudinal ends of the two support strips and designed to connect the two support strips, at least two of the resistance threads having at least two different lengths so as to be maintained in separated manner from one another in an orthogonal direction to the longitudinal axes of the support strips.

34. A roping harness comprising a belt according to claim 18, and/or a pair of leg loops of a roping harness comprising:
two flexible support strips,
at least three resistance threads fixed to the longitudinal ends of the two support strips and designed to connect the two support strips, at least two of the resistance threads having at least two different lengths so as to be maintained in separated manner from one another in an orthogonal direction to the longitudinal axes of the support strips.
